(19) United States
(12) Patent Application Publication
(10) Pub. No.: US 2025/0348779 A1
(43) Pub. Date: Nov. 13, 2025

(54) PREDICTIVE ASSISTANCE IN DIGITAL CHANNELS USING CONTEXTUAL DATA

(71) Applicant: Wells Fargo Bank, N.A., San Francisco, CA (US)

(72) Inventors: Kristin Ann Ballinger, Antelope, CA (US); Jeremy J. Berry, Huntersville, NC (US); Tyua Larsen Fraser, Livermore, CA (US); Joel Scott Gardner, Charlotte, NC (US); Stephen Lloyd Sloan, University City, MO (US)

(21) Appl. No.: 18/661,303

(22) Filed: May 10, 2024

(51) Int. Cl. G06N 20/00

(52) U.S. Cl. CPC G06N 20/00

(57) ABSTRACT

A method may include: receiving, using a processing unit, a plurality of interactions with an electronic service from a computing device; detecting, with the processing unit, a lack of subsequent interaction with the electronic service that continues longer than a threshold period; after the detecting, inputting contextual data of the plurality of interactions into an intervention machine learning model, the intervention machine learning model including weights based on contextual data of past user interaction data and user requests for assistance; after the inputting, retrieving an output value from the trained machine learning model; determining that the output value is above a threshold value; based on the determining, transmitting a message to the computing device to initiate a communication session with a user associated with the plurality of interactions; receiving an indication that the message was accepted by the user; and establishing the communication session in response to receiving the indication.

### BACKGROUND

Online services often use virtual assistants, such as chatbots, to facilitate user engagement and provide support. When a user visits a webpage and remains on it for a predetermined period of time, a system may be configured to automatically present a chatbot interface to the user. The chatbot may be programmed to initiate conversation and respond to user inputs.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Like numerals having different letter suffixes may represent different instances of similar components. Some embodiments are illustrated by way of example, and not limitation, in the figures of the accompanying drawing.

FIG. 1 is a diagram illustrating the components of a client device and an application server according to various examples.

FIG. 2 is a diagram illustrating pipelines for training and using a machine learning model, according to various examples.

FIG. 3 is a time-based representation of a user session, according to various examples.

FIG. 4 is a flowchart illustrating a method of processing interactions of a user, according to various examples.

FIG. 5 is a block diagram illustrating a machine in the example form of computer system, within which a set or sequence of instructions may be executed to cause the machine to perform any one of the methodologies discussed herein, according to various examples.

### DETAILED DESCRIPTION

The following description outlines specific examples to provide a thorough understanding of various inventive aspects. It will be evident, however, to one skilled in the art that the present invention may be practiced without these specific details. References in the specification to “one example,” “an example,” “an illustrative example,” etc., indicate that the example described may include a particular feature, structure, etc. Still, every example may not necessarily include that particular feature. Additionally, such phrases do not imply a single example, and the features may be incorporated into other examples described. It may be appreciated that lists in the form of “at least one A, B, and C” may mean (A); (B); (C): (A and B); (B and C); or (A, B, and C). Similarly, items listed in the form of “at least one of A, B, or C” can mean (A); (B); (C): (A and B); (B and C); or (A, B, and C). Furthermore, using such phrases does not negate the possibility of other options (e.g., (D)).

Throughout this disclosure, components may perform electronic actions in response to different variable values (e.g., thresholds, user preferences, etc.). As a matter of convenience, this disclosure does not always detail where the variables are stored or how they are retrieved. In such instances, it may be assumed that the variables are stored on a storage device (e.g., Random Access Memory (RAM), cache, hard drive) accessible by the component via an Application Programming Interface (API) or other program communication method. Similarly, the variables may be assumed to have default values should a specific value not be described. End-users or administrators may use user interfaces to edit the variable values.

In various examples described herein, user interfaces are described as being presented to a computing device. The presentation may include data transmitted (e.g., a hypertext markup language file) from a first device (such as a web server) to the computing device for rendering on a display device of the computing device via a web browser. Presenting may separately (or in addition to the previous data transmission) include an application (e.g., a stand-alone application) on the computing device generating and rendering the user interface on a display device of the computing device without receiving data from a server.

Furthermore, the user interfaces are often described as having different portions or elements. Although in some examples, these portions may be displayed on a screen simultaneously, in others, the portions/elements may be displayed on separate screens such that not all portions/elements are displayed simultaneously. Unless explicitly indicated as such, the use of “presenting a user interface” does not infer either one of these options.

Additionally, the elements and portions are sometimes described as being configured for a particular purpose. For example, an input element may be configured to receive an input string, a selection from a menu, a checkbox, etc. In this context, “configured to” may mean presenting a user interface element capable of receiving user input. “Configured to” may additionally mean computer executable code processes interactions with the element/portion based on an event handler. Thus, a “search” button element may be configured to pass text received in the input element to a search routine that formats and executes a structured query language (SQL) query to a database.

In the digital interaction space, particularly when users engage with virtual assistants, a technical problem arises from the inability to accurately interpret user pauses. Some systems rely on time-based algorithms to decide when to offer help, which do not consider the multifaceted reasons behind a user's inactivity. This leads to a binary interpretation of user behavior, where any pause is treated the same.

Such an approach may result in systems that are either overly eager to interject, disrupting the user's flow, or conversely, systems that fail to recognize genuine instances of user struggle. From a technical standpoint, the failure of a system to recognize when a user needs help can lead to inefficient resource allocation and suboptimal system performance. When a system cannot differentiate between a user who has paused intentionally and one who is experiencing difficulties, it may either allocate resources unnecessarily (such as engaging a customer service representative when no real issue exists) or fail to allocate resources when they are critically needed (resulting in a user being left without support). This inefficiency may strain the system's operational abilities.

Moreover, the lack of accurate detection may skew the data collected during user interactions, leading to misleading analytics and insights. This may have a ripple effect on the system's overall learning and improvement cycle, as the data used to train machine learning models would not accurately represent user behavior. Consequently, the models may learn from flawed data, which can perpetuate and even amplify the system's inability to provide timely help. In the long term, this can result in a system that is less intelligent and less capable of adapting to users' needs, undermining the effectiveness of any machine learning-driven improvements intended to be implemented.

Described herein are machine learning models capable of analyzing a wide array of user interaction data. These models are trained to recognize complex behavioral patterns that indicate confusion or a need for help. By understanding the context of the user's current task and analyzing the actions leading up to the pause, the models may infer the most likely reason for the inactivity. This contextual analysis allows the system to tailor its responses, providing assistance that is both relevant and timely.

Furthermore, machine learning models may use historical interaction data to learn patterns of past behavior to predict future needs. This historical perspective enables the system to adapt its responses to the individual user. Additionally, these models may learn from each interaction to refine their predictive capabilities over time. As more data is collected, the system's ability to offer precise assistance improves. In cases where additional data sources are available, such as physiological responses from wearable devices, machine learning models may integrate this information to better understand a user's state.

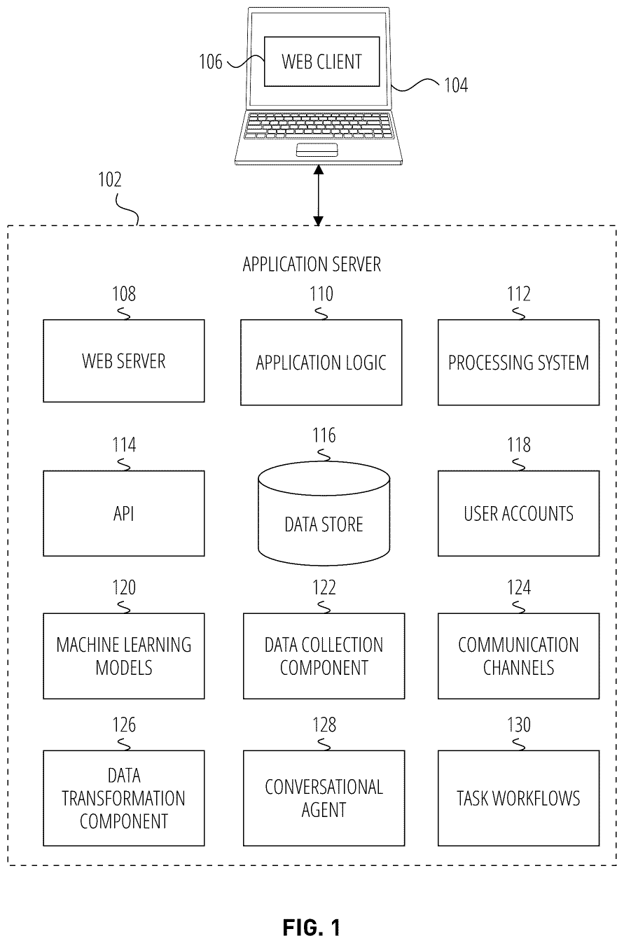

FIG. 1 is a diagram illustrating the components of a client device and an application server according to various examples. The application server 102 may include a web server 108, application logic 110, a processing system 112, an API 114, a data store 116, user accounts 118, machine learning models 120, a data collection component 122, communication channels 124, a data transformation component 126, a conversational agent 128, and task workflows 130.

Application server 102 may be part of an enterprise's digital infrastructure providing services to customers (also referred to as users), including online banking, e-commerce, media content delivery, social media, productivity software, etc. A user may interact with the service(s) via a client device 104 (e.g., using a web client 106). A user may use client device 104 to access and use the services provided by the enterprise via the web server 108. For example, if the enterprise provides banking services, the user may initiate a fund transfer between accounts, or if the enterprise is a cloud storage provider, the user may generate a new folder in their directory.

When users interact with a service provided by the enterprise, they may perform a series of operations (e.g., clicks, inputs, etc.) that correspond to a stored workflow in task workflows 130. For example, in the context of transferring funds between accounts, a user may perform the following steps:
1. Log into their online banking account using secure credentials.
2. Navigate to the funds transfer section of the banking service.
3. Enter the transfer details, such as the amount to be transferred, the source account, and the destination account.
4. Confirm the transaction.
5. Receive a confirmation that the funds have been transferred successfully.

A task workflow may be structured as a series of interconnected states or steps that represent the progression of a user's interaction with the service for that task. Each state may correspond to a specific point in the task, and user actions or system events trigger transitions between states. However, a workflow is not a rigid sequence of actions the user must follow; instead, it represents a framework within which the user's intent is determined. For example, a user may complete the first step of a workflow, perform five actions unrelated to the workflow, and then complete the second through fifth steps. In various examples, a task workflow may have variants depending on the user's device or interaction method. For example, instead of using a web application presented on a web page, the user may interact with conversational agent 128 (described further herein) to accomplish the task.

One of the problems users have with navigating web applications is not knowing the steps needed for a particular task. To counteract this problem, application server 102 may present a message on a web page asking the user if they need assistance and include a chat window. The chat window may be configured to respond to user queries automatically with conversational agent 128. Additionally, even if conversational agent 128 is being used, a user may become stuck and not know what to do. At this point, the conversational agent 128 may present an option to connect the user to a customer service representative.

Conversational agents, also called chatbots or virtual assistants, are software applications designed to simulate human-like conversations with users through text or voice interactions. These intelligent systems leverage a combination of pre-programmed rules and various forms of artificial intelligence (AI), including natural language processing (NLP) and machine learning (ML), to understand and respond to user queries naturally and intuitively. The underlying technology enables chatbots to process and interpret human language, recognize user intent, and generate relevant responses, facilitating interaction between the machine and human users. Conversational agents may be distinguished from pure Interactive Voice Response (IVR) systems in which a hierarchical menu is navigated using user selections (e.g., via a number pad on their phone) with no ML or AI.

For example, in the context of application server 102, conversational agent 128 may be configured (e.g., based on one of the models in machine learning models 120) to help guide a user through a task. Initially, conversational agent 128 may capture user input, which can be text or voice (via web client 106). Regarding text input, the conversational agent 128 may directly process the input. Speech recognition technology may convert spoken language into text format for voice inputs.

Upon receiving the input, the agent may use natural language processing (NLP) algorithms to analyze and understand the context and intent of the user's query. This step involves parsing the input, identifying key terms and phrases, and understanding the semantics to gauge the user's request or question accurately. Sentiment analysis may also be utilized to discern the emotional tone behind the user's message and stored by data collection component 122. In various examples, the conversational agent 128 may utilize a large language model (LLM) to process the input using a transformer model.

Following receiving the input, the conversational agent 128 may formulate a response. The response may be formulated based on the agent's architecture. For example, the agent may access a predefined knowledge base, make calls/queries to external databases and APIs to retrieve the information, or perform actions to address the user's request. This may involve querying databases for specific information, executing service-related tasks, or initiating processes that pertain to the user's input. The response may include data presented to the user and actions performed on the user's behalf. For example, suppose conversational agent 128 uses keywords to determine the intent for a specific task. In that case, the agent may query task workflows 130 to determine the steps a user should take to complete the task and guide the user through task completion.

The conversational agent 128 may be one of several communication channels an enterprise may use to communicate with a user. The logic for each communication method may be stored in communication channels 124. Communication channels may include, but are not limited to, voice customer service, interactive voice response (IVR), push notifications through a mobile app, and conversational agents.

The machine learning models 120 may include one or more machine learning models to facilitate interactions with the user. For example, a user intent machine learning model may be trained to classify a user's actions and determine which task in task workflows 130 the user is attempting to complete. An intervention machine learning model may be trained to output a probability a user needs assistance from either a conversational agent 128 or a live customer service representative (CSR). In particular, the intervention machine learning model may be used to determine if a user has stopped performing actions because they are stuck, have abandoned a workflow, or need additional help. In various examples, there may be an intervention machine learning model for each task workflows 130. In another example, a single intervention machine learning model uses a task workflow identifier (e.g., a task type) as an input. Another model may be a sentiment analysis (e.g., based on typing pressure, word choice entered into conversational agent 128) machine learning model to determine if a user is becoming frustrated.

Example architectures of machine learning models are discussed in greater detail in the following figures. However, briefly, data collection component 122 may (with user consent) collect data surrounding a user's actions, including, but not limited to, click stream data, physiological data, device telemetry data, device identifiers, user interface navigation path (e.g., a history of web pages). The collected information may be processed by data transformation component 126 to remove any personally identifiable information (PII) and generate standardized, quantitative values for each type of collected data. The processed data may then be encoded in a vector format and input into a machine learning model. The output of the machine learning model may be used to determine an action to take (e.g., present a message to connect the user to a CSR).

Application server 102 is illustrated as separate elements (e.g., components). However, the functionality of multiple individual elements may be performed by a single element. An element may represent computer program code executable by processing system 112. The program code may be stored on a storage device (e.g., data store 116) and loaded into the memory of the processing system 112 for execution. Portions of the program code may be executed in parallel across multiple processing units. A processing unit may be a grouping of one or more cores of a general-purpose computer processor, a graphical processing unit, an application-specific integrated circuit, or a tensor processing core. Furthermore, the grouping may operate on a single device or multiple devices (either collocated or geographically dispersed). Accordingly, code execution using a processing unit may be performed on a single device or distributed across multiple devices. In some examples, using shared computing infrastructure, the program code may be executed on a cloud platform (e.g., MICROSOFT AZURE® and AMAZON EC2®).

Client device 104 may be a computing device which may be but is not limited to, a smartphone, tablet, laptop, multi-processor system, microprocessor-based or programmable consumer electronics, game console, set-top box, or another device that a user utilizes to communicate over a network. In various examples, a computing device includes a display module (not shown) to display information (e.g., specially configured user interfaces). In some embodiments, computing devices may comprise one or more of a touch screen, camera, keyboard, microphone, or Global Positioning System (GPS) device.

Client device 104 and application server 102 may communicate via a network (not shown). The network may include local-area networks (LAN), wide-area networks (WAN), wireless networks (e.g., 802.11 or cellular network), Public Switched Telephone Network (PSTN), ad hoc networks, cellular, personal area networks or peer-to-peer (e.g., Bluetooth®, Wi-Fi Direct), or other combinations or permutations of network protocols and network types. The network may include a single Local Area Network (LAN), Wide-Area Network (WAN), or combinations of LANs or WANs, such as the Internet.

Web server 108 enables data exchanges with client device 104 (e.g., via web client 106). Although generally discussed in the context of delivering webpages via the Hypertext Transfer Protocol (HTTP), other network protocols may be utilized by web server 108 (e.g., File Transfer Protocol, Telnet, Secure Shell, etc.). A user may enter a uniform resource identifier (URI) into web client 106 (e.g., the INTERNET EXPLORER® web browser by Microsoft Corporation or SAFARI® web browser by Apple Inc.) that corresponds to the logical location (e.g., an Internet Protocol address) of web server 108. In response, web server 108 may transmit a web page rendered on a client device's display device (e.g., a mobile phone, desktop computer, etc.).

Additionally, web server 108 enables users to interact with a web application(s) in a transmitted web page. A web application provides user interface (UI) components rendered on a display device of the client device 104. The user may interact (e.g., select, move, enter text into) with the UI components, and, based on the interaction, the web application may update one or more portions of the web page. A web application may be executed in whole or in part locally on client device 104. The web application may populate the UI components with data from external or internal sources (e.g., data store 116) in various examples.

The web application may be executed according to application logic 110. Application logic 110 may use the various elements of application server 102 to implement the web application. For example, application logic 110 may issue API calls to retrieve or store data from data store 116 and transmit it for display on client device 104. Similarly, data entered by a user into a UI component may be transmitted back to the web server. Application logic 110 may use other elements (e.g., machine learning models 120, data collection component 122, communication channels 124, etc.) of application server 102 to perform functionality associated with the web application as described further herein.

Data store 116 may store data that is used by application server 102. Data store 116 is depicted as a singular element but may be multiple data stores. The data store 116 may include several databases of varying model architectures such as, but not limited to, a relational database (e.g., SQL), a non-relational database (NoSQL), a flat-file database, an object model, a document details model, graph database, shared ledger (e.g., blockchain), or a file system hierarchy. Data store 116 may store data on one or more storage devices (e.g., a hard disk, random access memory (RAM), etc.). The storage devices may be in standalone arrays, part of one or more servers, and located in one or more geographic areas.

Data structures may be implemented in several ways depending on the programming language of an application or the database management system used by an application. For example, if C++ is used, the data structure may be implemented as a struct or class. In the context of a relational database, a data structure may be defined in a schema.

In some examples, device communication may occur using an application programming interface (API) such as API 114. An API provides a method for computing processes to exchange data. A web-based API (e.g., API 114) may permit communications between two or more computing devices, such as a client and a server. The API may define a set of HTTP calls according to Representational State Transfer (RESTful) practices. For example, A RESTful API may define various GET, PUT, POST, and DELETE methods to create, replace, update, and delete data stored in a database (e.g., data store 116).

APIs may also be defined in frameworks provided by an operating system (OS) to access data in an application that an application may not regularly be permitted to access. For example, the OS may define an API call to obtain the current location of a mobile device the OS is installed on or physiological data (e.g., heart rate). In another example, an application provider may use an API call to request a user be authenticated using a biometric sensor on the mobile device. By segregating any underlying biometric data—e.g., by using a secure element—the risk of unauthorized transmission of the biometric data may be lowered.

User accounts 118 may include user profiles on users of application server 102. A user profile may include credential information such as a username and hash of a password. A user may enter their username and plaintext password on a login page of application server 102 to view their user profile information or interfaces presented by application server 102 in various examples. A user profile may also include the user's preferences. The preferences may include communication channel preferences that identify which communication channel the user prefers to be contacted with.

A user account may also identify computing devices associated with the user. For example, users may register one or more phones, desktop computers, tablets, or laptops with application server 102. Registering may include authorizing application server 102 to retrieve data from these devices, such as location data, browser history, etc. Users may revoke access to such data anytime by updating their profile. The data may be gathered via an application installed on a registered device, such as by downloading an application from an app store associated with their mobile phone platform.

“Associated” in the context of linking an account to a user profile (or other data linkages described herein) may be implemented differently depending on the underlying database system. For example, in a relational database management system (RDBMS), “associated” may refer to the relationship between tables. The relationship could be one-to-one, one-to-many, or many-to-many, established through foreign key constraints. For example, in a one-to-many relationship, a record in Table A (e.g., the user profile table) may be associated with multiple records in Table B (e.g., a user account table), using a foreign key in Table B that references the primary key in Table A.

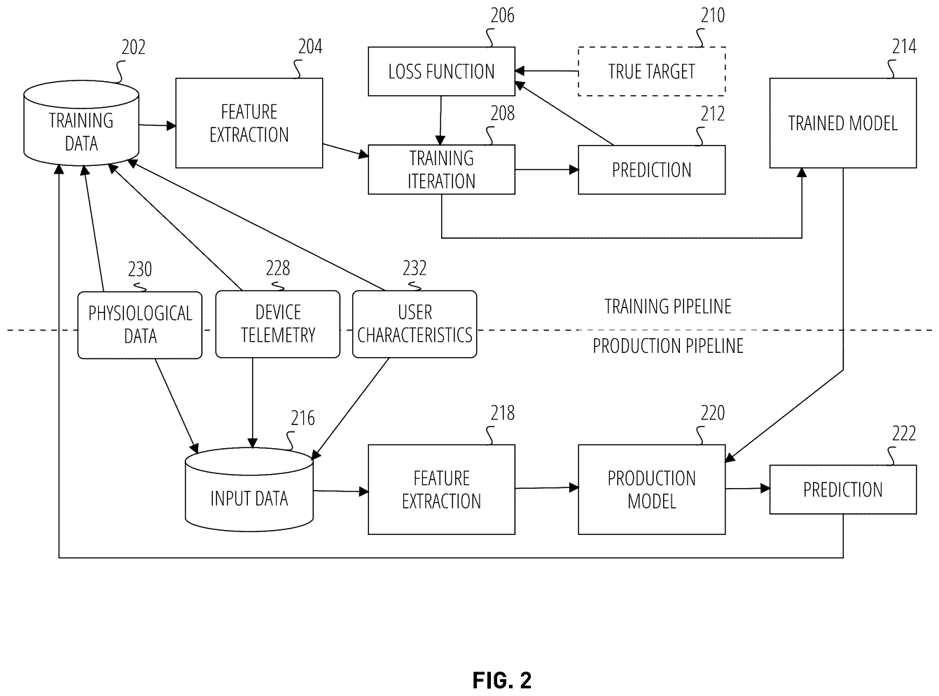

FIG. 2 is a diagram illustrating pipelines for training and using a machine learning model, according to various examples. Machine learning encompasses different algorithms used to predict or classify a data set. In general terms, there are three types of ML algorithms: supervised learning, unsupervised learning, and reinforcement learning-sometimes, a fourth, semi-supervised learning is also used.

Supervised learning algorithms may make a prediction based on a labeled data set (e.g., text with a rating of whether it is spam) and are generally used for classification, regression, or forecasting. Some examples of supervised learning algorithms are Naïve Bayes, Support Vector Machines, Linear Regression, Logistic Regression, Decision Trees, Random Forests, and K-Nearest Neighbor. Unsupervised learning algorithms may use an unlabeled data set (e.g., looking for clusters of similar data based on common characteristics). An example of an unsupervised learning algorithm is K-mean clustering.

Reinforcement learning algorithms generally make a prediction/decision, and then a user determines whether the prediction/decision was right-after which the machine learning model may be updated. This type of learning may be helpful when a limited input data set is available.

Neural networks (also called artificial neural networks (ANN)) are a subset of ML algorithms that may be used to solve problems similar to those of the machine learning algorithms listed above. ANNs are computational structures that are loosely modeled on biological neurons. Generally, ANNs encode information (e.g., data or decision making) via weighted connections (e.g., synapses) between nodes (e.g., neurons). ANNs have many AI applications, such as automated perception (e.g., computer vision, speech recognition, contextual awareness, etc.), automated cognition (e.g., decision-making, logistics, routing, supply chain optimization, etc.), automated control (e.g., autonomous cars, drones, robots, etc.), among others. The weights may be updated during the training process using a gradient descent technique.

Regarding FIG. 2, training a machine learning model begins by collecting training data 202. The training data 202 may include context data collected by data collection component 122 and include physiological data 230, device telemetry 228, and user characteristics 232. Physiological data 230 may include data (e.g., heart rate) collected from the biometric sensor of a computing device (e.g., a smartwatch) that the user has granted permission to share such data. Device telemetry 228 may include but is not limited to, typing pressure, typing speed (e.g., as measured by the time between keypresses), device type (e.g., mobile device, desktop), operating system, clickstream data (e.g., which UI elements a user has selected) with timestamps, browser type, etc. The user characteristics 232 may be demographic information (e.g., age, communication preferences) accessed from a user's profile.

The training data 202 may be labeled according to past user interaction sessions. Each session may be defined as a sequence of user actions commencing with an attempt to perform a task and concluding with an outcome. For example, the outcomes may be categorized into four labels: ‘Completed,’ ‘Abandoned,’ ‘Responded to Invitation,’ and ‘Declined Invitation.’ A session is labeled ‘Completed’ upon the successful finalization of the task by the user without additional help or intervention by a conversational agent or CSR, ‘Abandoned’ if the user ceases interaction for a predetermined duration or logs out, ‘Responded to Invitation’ if the user accepts a system-generated offer to communicate with a customer service representative, and ‘Declined Invitation’ if the user dismisses the offer and proceeds without assistance. The training data 202 may include a balanced amount of each outcome to generate unbiased model training. Each session within the corpus may include the associated physiological data 230, device telemetry 228, and user characteristics 232, as discussed previously.

Feature extraction 204 may include normalization and quantification of the training data 202. For example, a vector having one or more dimensions may be generated and include data encoded from each past user interaction session. Numerical data, such as time spent on a task or the number of actions taken, may be directly used as vector components after normalization to ensure consistent scale across the dataset. Categorical data, such as the task type (e.g., of a task workflow) or type of device used, use encoding into a numerical format, often through one-hot encoding. One-hot encoding represents each possible category/type by a binary vector with a ‘1’ in the position corresponding to the category and ‘0’s elsewhere. User action sequences may use a vector format where each component of the vector identifiers is a user interface element identifier clicked by a user.

A training iteration 208 may include inputting a session, as encoded into a vector format, into a machine learning model (e.g., neural network, k-means clustering algorithm). The model may then output prediction 212. For a neural network, outputting the prediction may include outputting a vector where each vector element represents a possible outcome (e.g., completed, abandoned, etc.). The set of possible outcomes may match the labels in the training data 202. For k-means clustering, outputting may include identifying a cluster.

The prediction 212 may be compared to the true target 210, depending on the model type. A true target may be the actual category the session is associated with. The loss function 206 evaluates the model's performance (e.g., how well the predictions match the actual outcomes). Based on this evaluation, the model's parameters (like weights in neural networks) are updated to minimize the loss, such as using gradient descent. In other models, like decision trees, the update mechanism might involve choosing different splits in the data or pruning branches to improve the model's accuracy, or for k-means clustering, the centroids may be recalculated. After a stopping condition, such as the number of epochs for neural network or convergence, the model may be considered trained (e.g., trained model 214).

Turning to the production pipeline of FIG. 2, the trained model 214 is used as the production model 220. Input data 216 may include real-time data of users currently interacting with application server 102. For example, for a current user session, physiological data 230, device telemetry 228, and user characteristics 232 data may be collected and encoded into an input vector at feature extraction 218. The production model 220 may then generate prediction 222, which is a probability that, based on the current session, the user will complete, abandon, decline an invitation, or accept an invitation for additional help via a CSR. If the additional help category has the highest probability, a message may be transmitted to the computing device the user is currently using.

The production model 220 may be updated based on user reactions. For example, after a user session has ended, a pop-up question may be presented asking the user to rate their experience. Over time, the survey data may be collected and used as further training data to increase the accuracy of the production model 220.

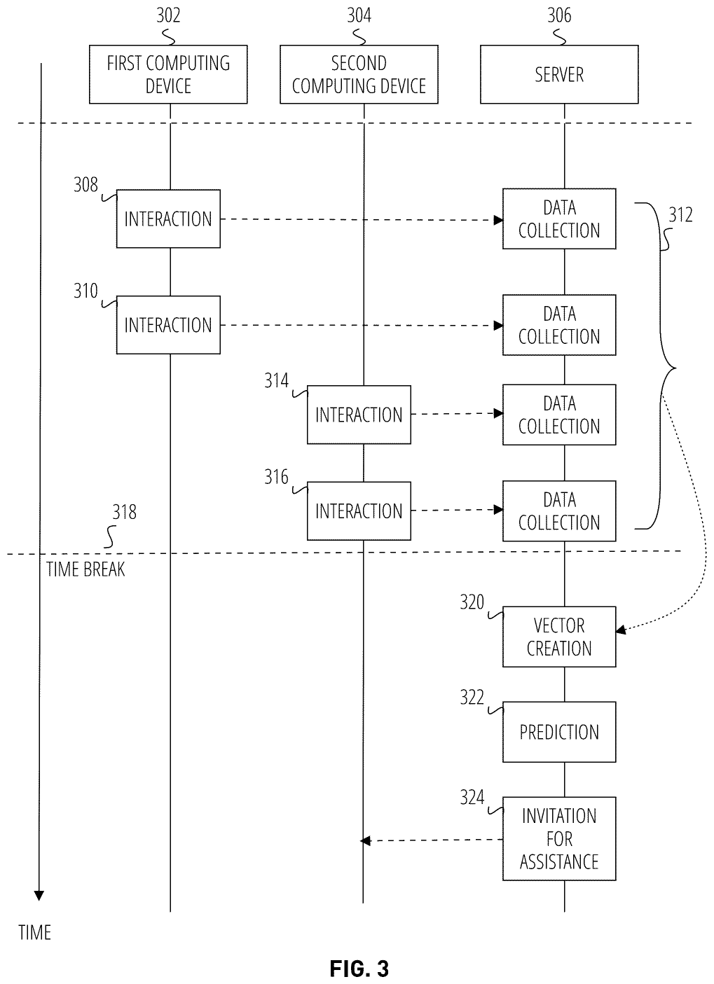

FIG. 3 is a diagram of a time-based representation of a user session, according to various examples. FIG. 3 includes two computing devices, a first computing device 302, and a second computing device 304. Both computing devices may be associated with a user account (e.g., in user accounts 118). The first computing device 302 may be devices such as described for client device 104 but in different form factors. For example, the first computing device 302 may be a smartphone device, and the second computing device 304 may be a laptop device. In various examples, server 306 is a server as described for application server 102. Although four interactions are presented in FIG. 3, a user session may include more or fewer.

The user session may be one in which a user is using the first computing device 302 with a mobile app and is attempting to perform a task. For this example, consider the user attempting to set up a bill payment to a payee for a future date. Thus, interaction 308 may be the user selecting an option in the mobile app to navigate to an account services section. Then, interaction 310 may be a user selecting a “manage bill pay” link. However, the user may not know what to do or cannot make the proper selections. So, the user switches to another device (e.g., second computing device 304) to try and set up the bill pay via a web application. After signing in, interaction 314 may again navigate to the bill pay section of the website. Then, however, the user sees an option to begin a conversation with a virtual assistant. Accordingly, interaction 316 may initiate a chat with the virtual assistant (e.g., such as conversational agent 128). However, even with the virtual assistant, the user may become stuck and cease interactions for a while (the time break 318).

If time break 318 exceeds a minimum duration (e.g., thirty seconds), data collection 312 from each interaction may be gathered and used to generate one or more feature vectors (vector creation 320). The data collection may include several data types, such as those discussed for feature extraction 218 of FIG. 2. For example, information for interaction 308 may be <timestamp, device type of first computing device 302, universally unique identifier (UUID) for the link to the account services section of the mobile app, user identifier, mobile operating system version>. Vector creation 320 may encode the data into a numerical format for inputting into one or more machine learning models. The vector inputted into a machine learning model may be a vector of vectors (e.g., <<vector of data for interaction 308>, <vector of data for interaction 310> . . . >.

Furthermore, vector creation 320 may generate different vectors depending on the number of machine learning models used. For example, vector creation 320 may include a set of vectors of clickstream data and timestamps for a user intent machine learning model. Then, vector creation 320 may create an input vector for an intervention machine learning model that adds the output of the user intent machine learning model with physiological data of data collection 312.

Prediction 322 may be based on the values of the intervention machine learning model's output nodes. Each node may represent an action that the server 306 may take. For example, one node may represent the probability that the user would prefer a call with a CSR, and another node may represent the probability that the user is just pausing.

In FIG. 3, prediction 322 may lead to a decision to transmit an invitation for assistance 324 to the second computing device 304. The invitation may be a message within the virtual agent to connect the user to a CSR.

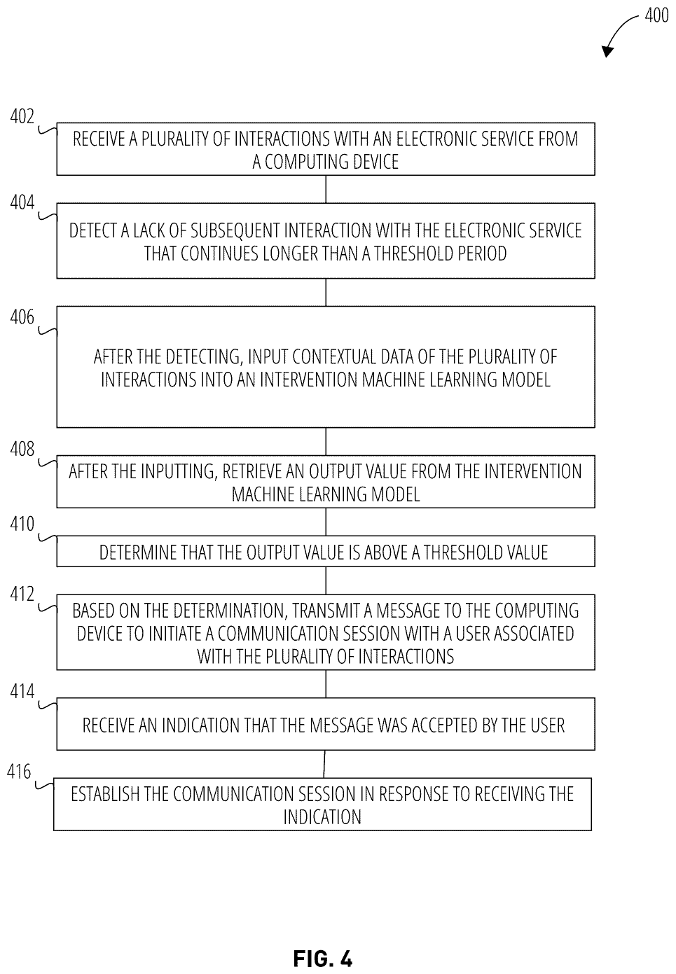

FIG. 4 is a flowchart illustrating a method of processing user interactions, according to various examples. The method is represented as a set of blocks that describe operation 402 through operation 416. The method may be embodied in a set of instructions stored in at least one computer-readable storage device of a computing device. A computer-readable storage device excludes transitory signals. In contrast, a signal-bearing medium may include such transitory signals. A machine-readable medium may be a computer-readable storage device or a signal-bearing medium. A processing unit, which when executing the set of instructions, may configure the processing unit to perform the operations illustrated in FIG. 4. The processing unit may instruct other component of a computing device to carry out the set of instructions. For example, the processing unit may instruct a network device to transmit data to another computing device or the computing device may provide data over a display interface to present a user interface. In some examples, performance of the method may be split across multiple computing devices using a shared computing infrastructure (e.g., the processing unit encompasses multiple distributed computing devices).

In various examples, the method includes receiving a plurality of interactions with an electronic service from a computing device at operation 402. For example, the computing device may one such as client device 104 in FIG. 1. The plurality of interactions may be received at a server such as application server 102.

The contextual data of the plurality of interactions may a number of computing devices of the user communicating with the electronic service during a period of time. The contextual data may also include a sequence of the number of computing devices communicating with the electronic service during the period of time. The first and second computing devices may be of different types. For example, the first computing device may be a smartphone and the second computing device may be a laptop computer. The “number of computing devices” would be two (2) in such an instance. Each computing device may have an identifier (e.g., the first computing device is ‘1’ and the second is ‘2’). Accordingly, the sequence may be <1, 2>. In other examples the computing device identifier may be part of the interaction data for an individual interaction.

The contextual data may also include telemetry data (e.g., device telemetry 224) and physiological behavioral characteristics (e.g., physiological data 226) for one or more of the interactions in the plurality of interactions.

In various examples, the method includes detecting a lack of subsequent interaction (e.g., no interactions are received) with the electronic service that continues longer than a threshold period at operation 404. The threshold period may differ depending on the type of interaction. For example, if the user is interacting with a virtual assistant (such as conversational agent 128) the period may be set to 20 seconds, but the user is interacting with the website, the period may be 30 seconds.

The method may further include classifying the plurality of interactions as a task type. The task type may be added as part of the contextual data. The task type of the plurality of interactions may be received explicitly from the user (e.g., the user has selected from a set of options) or based on a user intent machine learning model as discussed above. The contextual data may also include a level of progress within the task type. Consider a task workflow associated with the task type includes five (5) steps, and the plurality of interactions indicates a user has completed the first three (3). The progress may be represented as 0.6 (e.g., 60%).

In various examples, the method includes after the detecting, inputting contextual data of the plurality of interactions into an intervention machine learning model at operation 406. The intervention machine learning model may include weights based on contextual data of past user interaction data and user requests for assistance. Inputting the contextual data may include encoding the contextual data into a vector format, as discussed for feature extraction 218 for FIG. 2. The number of interactions in the plurality of interactions may be set according to time, number of interactions, or event. For example, the plurality of interactions may include the past 50 interactions, the past 15 minutes or actions, all actions since the user has most recently authenticated, or combinations thereof.

In various examples, the method includes after the inputting, retrieving an output value from the intervention machine learning model at operation 408. For example, suppose the intervention machine learning model is a neural network. In that case, the output value may be a value of an output node associated with a possible action to take, such as do nothing because the user is likely pausing, nothing because the user has abandoned the task, or present intervention option because the user is likely stuck.

In various examples, the method includes determining that the output value is above a threshold value at operation 410. For example, the output node for intervening may be above 0.85. The method may include based on the determination, transmitting a message to the computing device to initiate a communication session with a user associated with the plurality of interactions at operation 412. The message may be transmitted to the most recently used computing device, for example. In other examples, the message may be transmitted via a communication channel preferred by the user in their user profile. Accordingly, the method may include selecting a communication channel of a plurality of communication channels and configuring the communication channel (e.g., placing a phone call, presenting a message in a chat window, etc.) to establish the communication session.

In various examples, the method includes receiving an indication that the message was accepted by the user at operation 414. For example, the user may activate a link in the message. The method may include establishing the communication session in response to receiving the indication at operation 416. Additionally, the method may include updating the intervention machine learning model weights based on the indication that the user accepted the message. For example, the indication (and the plurality of interactions) may be used as training input to update the intervention machine learning model, as discussed in FIG. 2.

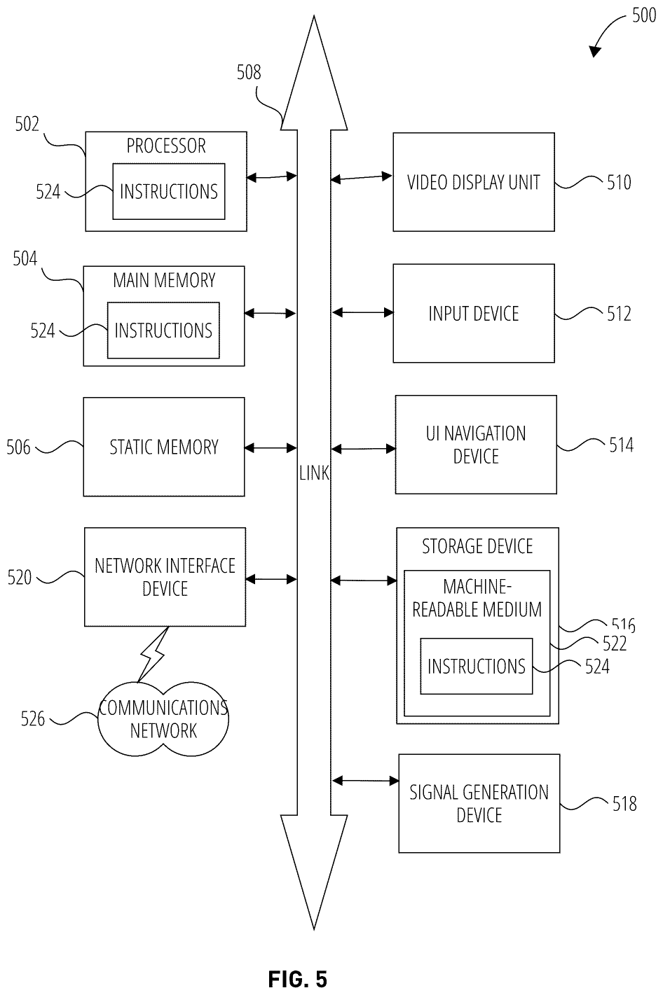

FIG. 5 is a block diagram illustrating a machine in the example form of computer system 500, within which a set or sequence of instructions may be executed to cause the machine to perform any of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) Network environments. The machine may be an onboard vehicle system, wearable device, personal computer (PC), tablet PC, hybrid tablet, personal digital assistant (PDA), mobile telephone, or any machine capable of executing instructions (sequential or otherwise) that specify actions to be taken by that machine. Further, while only a single machine is illustrated, the term “machine” includes any collection of machines that individually or jointly execute a set (or multiple sets) of instructions to perform any of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein

Example computer system 500 includes at least one processor 502 (e.g., a central processing unit (CPU), a graphics processing unit (GPU) or both, processor cores, compute nodes, etc.), a main memory 504, and a static memory 506, which communicate with each other via a link 508. The computer system 500 may include a video display unit 510, an input device 512 (e.g., a keyboard), and a user interface UI navigation device 514 (e.g., a mouse). In an example, the video display unit 510, input device 512, and UI navigation device 514 are incorporated into a single device housing, such as a touchscreen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, or other sensors.

The storage device 516 includes a machine-readable medium 522 on which one or more sets of data structures and instructions 524 (e.g., software) embodying or utilized by any of the methodologies or functions described herein. The instructions 524 may also reside, completely or at least partially, within the main memory 504, the static memory 506, or within the processor 502 during execution thereof by the computer system 500, with the main memory 504, the static memory 506, and the processor 502 also constituting machine-readable media.

While the machine-readable medium 522 is illustrated in an example embodiment to be a single medium, the term “machine-readable medium” may include a single medium or multiple media (e.g., a centralized or distributed database or associated caches and servers) that store the instructions 524. The term “machine-readable medium” shall also be taken to include any tangible medium that is capable of storing, encoding, or carrying instructions for execution by the machine and that causes the machine to perform any one or more of the methodologies of the present disclosure or that is capable of storing, encoding or carrying data structures utilized by or associated with such instructions. The term “machine-readable medium” includes, but is not limited to, solid-state memories and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. A computer-readable storage device may be a machine-readable medium 522 that excludes transitory signals.

The instructions 524 may be transmitted or received over a communications network 526 using a transmission medium via the network interface device 520 utilizing a transfer protocol (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine and includes digital or analog communications signals or other intangible mediums to facilitate communication of such software

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

What is claimed is:

1. A computer-implemented method comprising:
receiving, using a processing unit, a plurality of interactions with an electronic service from a computing device;
detecting, with the processing unit, a lack of subsequent interaction with the electronic service that continues longer than a threshold period;
after the detecting, inputting contextual data of the plurality of interactions into an intervention machine learning model, the intervention machine learning model including weights based on contextual data of past user interaction data and user requests for assistance;
after the inputting, retrieving an output value from the intervention machine learning model
determining that the output value is above a threshold value;
based on the determining, transmitting a message to the computing device to initiate a communication session with a user associated with the plurality of interactions;
receiving an indication that the message was accepted by the user; and
establishing the communication session in response to receiving the indication.

2. The computer-implemented method of claim 1, wherein the contextual data of the plurality of interactions includes a number of computing devices of the user communicating with the electronic service during a period of time.

3. The computer-implemented method of claim 2, wherein the contextual data includes a sequence of the number of computing devices communicating with the electronic service during the period of time.

4. The computer-implemented method of claim 2, wherein a first computing device of the number of computing devices is of a first type and a second computing device of the number of computing devices is a second type, wherein the first type and second type are different types of computing devices.

5. The computer-implemented method of claim 1, wherein inputting contextual data of the plurality of interactions into the machine learning model comprises encoding the contextual data into a vector format.

6. The computer-implemented method of claim 1, further comprising:
classifying the plurality of interactions as a task type; and
inputting the task type into the intervention machine learning model with the contextual data.

7. The computer-implemented method of claim 6, wherein the contextual data includes a level of progress within the task type.

8. The computer-implemented method of claim 1, wherein the contextual data includes physiological behavioral characteristics of the plurality of interactions.

9. The computer-implemented method of claim 1, wherein the contextual data includes telemetry data of the plurality of interactions.

10. The computer-implemented method of claim 1, further including:
updating the weights of the intervention machine learning model based on receiving the indication that the message was accepted by the user.

11. The computer-implemented method of claim 1, wherein transmitting the message to the computing device to initiate the communication session with the user associated with the plurality of interactions:
selecting, using the processing unit, a communication channel of a plurality of communication channels; and
configuring the communication channel to establish the communication session.

12. A non-transitory computer-readable medium comprising instructions, which when executed by a processing unit, configure the processing unit to perform operations comprising:
receiving a plurality of interactions with an electronic service from a computing device;
detecting a lack of subsequent interaction with the electronic service that continues longer than a threshold period;
after the detecting, inputting contextual data of the plurality of interactions into an intervention machine learning model, the intervention machine learning model including weights based on contextual data of past user interaction data and user requests for assistance;
after the inputting, retrieving an output value from the intervention machine learning model
determining that the output value is above a threshold value;
based on the determining, transmitting a message to the computing device to initiate a communication session with a user associated with the plurality of interactions;
receiving an indication that the message was accepted by the user; and
establishing the communication session in response to receiving the indication.

13. The computer-implemented method of claim 12, wherein the contextual data of the plurality of interactions includes a number of computing devices of the user communicating with the electronic service during a period of time.

14. The computer-implemented method of claim 13, wherein the contextual data includes a sequence of the number of computing devices communicating with the electronic service during the period of time.

15. The computer-implemented method of claim 13, wherein a first computing device of the number of computing devices is of a first type and a second computing device of the number of computing devices is a second type, wherein the first type and second type are different types of computing devices.

16. The computer-implemented method of claim 12, wherein inputting contextual data of the plurality of interactions into the machine learning model comprises encoding the contextual data into a vector format.

17. The computer-implemented method of claim 12, wherein the instructions, which when executed by the processing unit, further configure the processing unit to perform operations comprising:
classifying the plurality of interactions as a task type; and
inputting the task type into the intervention machine learning model with the contextual data.

18. The computer-implemented method of claim 17, wherein the contextual data includes a level of progress within the task type.

19. The computer-implemented method of claim 12, wherein the contextual data includes physiological behavioral characteristics of the plurality of interactions.

20. A system comprising:
a processing unit;
a storage device comprising instructions, which when executed by the processing unit, configure the processing unit to perform operations comprising:
receiving a plurality of interactions with an electronic service from a computing device;
detecting a lack of subsequent interaction with the electronic service that continues longer than a threshold period;
after the detecting, inputting contextual data of the plurality of interactions into an intervention machine learning model, the intervention machine learning model including weights based on contextual data of past user interaction data and user requests for assistance;
after the inputting, retrieving an output value from the intervention machine learning model
determining that the output value is above a threshold value;
based on the determining, transmitting a message to the computing device to initiate a communication session with a user associated with the plurality of interactions;
receiving an indication that the message was accepted by the user; and
establishing the communication session in response to receiving the indication.
